(19) United States
(12) Patent Application Publication
(10) Pub. No.: US 2009/0208745 A1
(43) Pub. Date: Aug. 20, 2009

(54) COMPOSITE MATERIAL PLACEMENT

(75) Inventor: Bradley John Blonigen, Wichita, KS (US)

Correspondence Address: HOVEY WILLIAMS LLP, 10801 Mastin Blvd., Suite 1000, Overland Park, KS, 66210, US

(73) Assignee: Spirit AeroSystems, Inc., Wichita, KS (US)

(21) Appl. No.: 12/031,175

(22) Filed: Feb. 14, 2008

(51) Int. Cl. B32B 5/08; B29C 55/18; B65H 69/02

(52) U.S. Cl. 428/401; 264/280; 156/158

(57) ABSTRACT

A method of applying a length of discontinuous fiber material to a surface comprises placing the material between a roller and the surface, urging the roller toward the surface such that the roller causes at least a portion of the length of discontinuous fiber material to engage the surface, and applying the length of discontinuous fiber material to the surface by moving one of said roller and said surface relative to the other such that the roller rolls along an application path of said surface. The application path may include one or more curves, wherein a first portion of the material lengthens relative to a second portion of the material, thereby allowing the material to lay evenly against the surface through the one or more curves without separating from the surface.

### BACKGROUND

1. Field

The present technology relates to manufacturing processes involving the placement and curing of fibrous materials to form composite structures. More particularly, various embodiments of the technology involve an automated method of applying a fibrous material to a mold surface that enables a length of the material to be placed along a non-linear path of the mold surface with little or no separation from the surface.

2. Related Art

In the manufacture of composite material structures, such as components for airplanes and other vehicles, a fibrous material may be applied to a mold surface, impregnated with a resin, and then cured to form a hardened structure presenting a shape defined by the mold surface. The material may be applied to the surface from spools of elongated strips, wherein each strip is fed to a compaction roller, interposed between the roller and the surface, and “rolled” onto the surface by moving one of the roller and the surface relative to the other.

Unfortunately, this process suffers from various limitations. Because the elongated strips of material are flat, for example, they may “bunch up” or otherwise separate from the surface if they are not applied along a relatively straight line.

Accordingly, there is a need for an improved method of applying a material to a surface that does not suffer from the problems and limitations of the prior art.

### SUMMARY

The present technology provides an improved process of manufacturing composite material structures. Particularly, embodiments of the present technology provide a method of applying a fibrous material to a mold surface that enables a length of the material to be placed along a non-linear path of the mold surface with little or no separation from the surface.

A length of discontinuous fiber material is placed between a roller and a mold surface, wherein the length of discontinuous fiber material is substantially flat with a first longitudinal edge and a second longitudinal edge separated by a span of the material. The roller is urged toward the surface such that the roller causes at least a portion of the material to engage the surface.

The material is applied to the surface by moving one of the roller and the surface relative to the other such that the roller rolls along a path of the surface. The path includes a curve wherein a first path edge corresponding to the first longitudinal edge of the material is longer through the curve than a second path edge corresponding to the second longitudinal edge of the material. A first portion of the material proximate the first longitudinal edge lengthens relative to a second portion of the material proximate the second longitudinal edge, thereby allowing the length of material to lay against the surface through the curve with little or no separation from the surface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Preferred implementations of the present technology are described in detail below with reference to the attached drawing figures, wherein:

FIG. 1 is a perspective view of an exemplary material placement system that may be used according to a method of the present technology;

FIG. 2 is a cross-sectional view of a roller of the material placement system of FIG. 1, illustrating the placement of a length of material to a surface;

FIG. 3 is a perspective view of a plurality of rollers that may be associated with the material placement system of FIG. 1;

FIG. 4 is a plan view of a plurality of portions of material applied to a surface using the rollers of FIG. 3, wherein each of the portions of the material follows a curved path;

FIG. 5 illustrates various lengths of material applied to a surface along a curved path, wherein portions of the material has separated from the surface;

FIG. 6 is a perspective view of a length of discontinuous fiber material used according to a method of the present technology;

FIG. 7 illustrates the material of FIG. 6 placed on a surface along a path presenting two curves, the material laying flat against the surface through both of the curves;

FIG. 8 is a perspective view of an exemplary spool of discontinuous carbon fiber material; and

FIG. 9 is an end elevation view of the spool of FIG. 8.

### DETAILED DESCRIPTION

The following detailed description of the present technology references the accompanying drawings that illustrated specific embodiments in which the technology can be practiced. The embodiments are intended to describe aspects of the technology in sufficient detail to enable those skilled in the art to practice the technology. Other embodiments can be utilized and changes can be made without departing from the scope of the present teachings. The following detailed description is, therefore, not to be taken in a limiting sense. The scope of the present invention is defined only by the appended claims, along with the full scope of equivalents to which such claims are entitled.

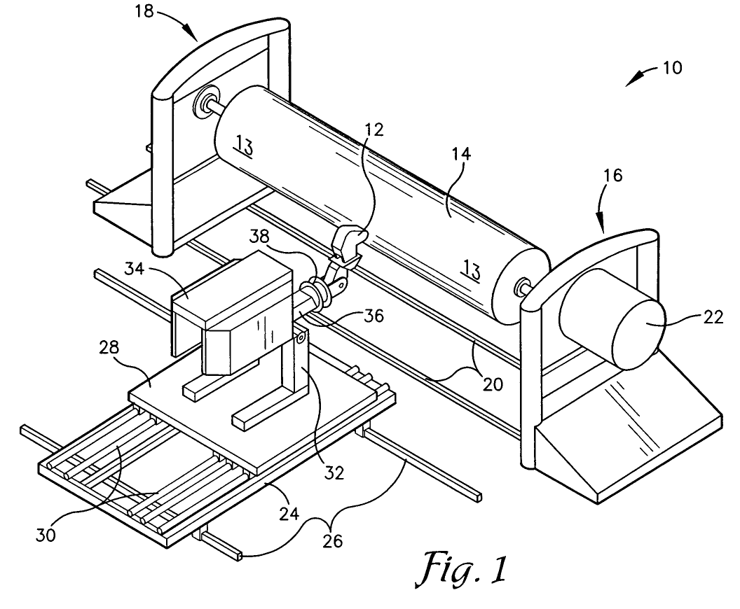

An exemplary material application system embodying principles of the present teachings is illustrated in FIG. 1 and designated generally by the reference numeral 10. The material application system 10 includes a material placement head 12 that applies material to a mold surface, such as an outer surface 13 of a mandrel 14, as part of a process of manufacturing a composite material structure. The mandrel 14 is supported by a headstock 16 and a tailstock 18. The headstock 16 and the tailstock 18 are mounted on a first set of linear ways 20, which in turn are fixed to a floor of a building, a machine bed, or similar external structure. The headstock 16 includes an actuator 22 for rotating the mandrel 14 about a longitudinal axis of the mandrel 14 that is generally parallel to the ways 20. One or both of the headstock 16 and the tailstock 18 is moveable along the ways 20 to adjust the distance between the headstock 16 and the tailstock 18, thereby facilitating placement of the mandrel 14 and accommodating mandrels of varying sizes and shapes.

A carriage 24 is moveably mounted on a second set of linear ways 26 and is moveable along an axis that is generally parallel to the first set of linear ways 20. A cross member 28 is mounted on a third set of linear ways 30 which are fixed to the carriage 24 in a direction generally perpendicular to the second set of linear ways 26. The cross member 28 is moveable on the third set of linear ways 30 along an axis that is generally parallel to the ways 30.

A base 32 rests on the carriage 24 and supports a creel 34 and an arm 36. The creel 34 includes a generally enclosed cabinet for housing a plurality of lengths of material, such as spools of fibrous tow, fed to the placement head 12 for placement on the surface 13. The material is threaded through a series of redirects (not shown) out of the creel 34 to the delivery head 12.

The arm 36 includes a robotic wrist 38 for positioning the delivery head 12 in various positions relative to the surface of the mandrel 14. The wrist may impart a motion to the head 12 that includes rotation about an axis which is essentially parallel with a longitudinal axis of the arm 36 and/or about an axis which is essentially perpendicular with a longitudinal axis of the arm 36.

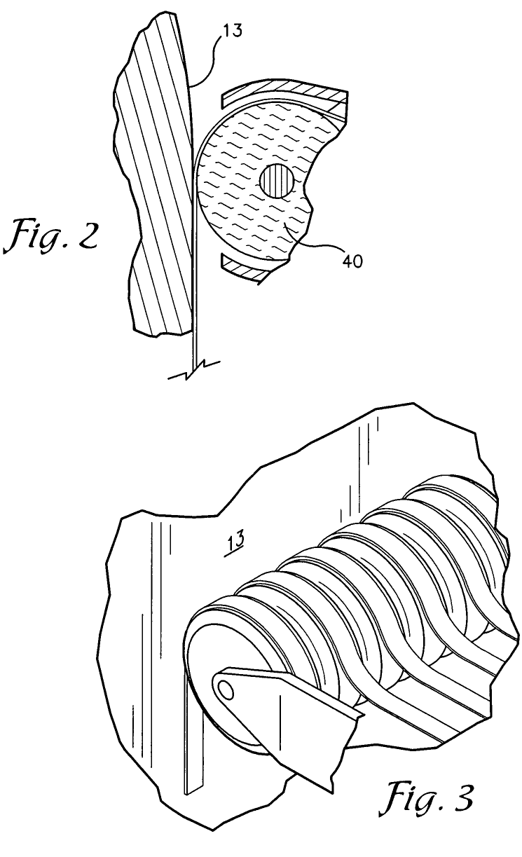

The material placement head 12 applies one or more lengths of material to an outer surface of the mandrel 14 as the mandrel 14 is rotated by the actuator 22. The outer surface of the mandrel 14 may generally define a shape of a composite material structure to be manufactured. As illustrated in FIG. 2, the placement head 12 includes at least one roller 40 for applying the material to the surface 13 of the mandrel 14, and may include a plurality of rollers as illustrated in FIG. 3, each roller configured to apply a portion of material to the surface 13 of the mandrel 14. In the configuration illustrated in FIG. 3, each portion of material is placed on the surface proximate or adjacent another portion of material.

The form and function of the system 10 are exemplary in nature, and other, equally-preferred systems may be employed without departing from the ambit of the present teachings. While the illustrated mandrel 14 of the system 10 rotates and the placement head 12 is relatively stationary, for example, an alternative system may include a stationary surface and a placement head that moves relative to the stationary surface.

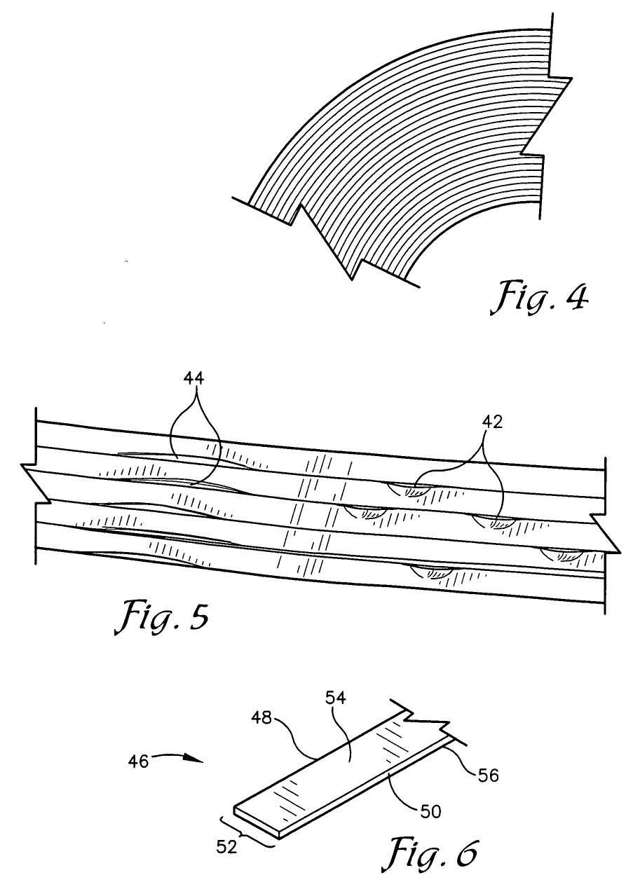

In certain applications it may be desirable to apply one or more lengths of material to the surface 13 along a curved path, as illustrated in FIG. 4. Unfortunately, applying material along a curved path presents challenges that may impede proper placement and curing of the material. As illustrated in FIG. 5, for example, material applied along a curved path may separate from the surface 13 along radially inner portions 42, where the material “bunches,” and along radially outer portions 44, where the material is over-extended.

The present technology provides a method of applying fibrous material to a surface along a curved path with little or no separation from the surface by employing a discontinuous fiber material 46, illustrated in FIG. 6. The material 46 is applied to the surface 13 of the mandrel 14 in lengths or strips, and each length includes a first longitudinal fiber edge 48 and a second longitudinal fiber edge 50, the first edge 48 being separated from the second edge 50 by a width 52 or span of the fiber material 46. The discontinuous fiber material 46 includes a first side 54 and a second side 56.

The discontinuous fiber material 46 may include glass fibers, carbon fibers, ceramic fibers, and/or other types of fibers or filaments generally running along a length of the material 46. Thus, the individual fibers are generally parallel with the edges 48,50 of the material 46. At least some of the fibers are discontinuous in that they extend along only a portion of the length of the material 46. As explained below, discontinuous fiber is advantageous in that the fibers of the material 46 can slide or move relative one another to allow portions of the material 46 to lengthen without tearing or separating from the surface 13. An example of a discontinuous fiber material is stretch-broken carbon fiber. Stretch breaking involves stretching the material to the point that at least some of the fibers constituting the material break, leaving the material intact and comprising a plurality of shortened fibers. Various examples of systems and methods of producing stretch-broken fibrous material are set forth in U.S. Pat. Nos. 6,477,740, 4,825,635, and 4,759,985.

The precise length of each fiber or filament strand of the material 46 is not critical to the present technology and may vary from one application to another, or even from one length of the material 46 to another within the same application. By way of example, each fiber strand may have a length within the range of from about 0.5 cm to about 20 cm; within the range of from about 4.0 cm to about 16 cm; or within the range of from about 8.0 cm to about 12 cm. Similarly, the precise width 52 of the discontinuous fiber material is not critical to the present technology and may vary from one application to another, but by way of example the width 52 of the material 46 may be within the range of from about 1.0 mm to about 20.0 cm, within the range of from about 5.0 mm to about 15.0 cm, or within the range of from about 1.0 cm to about 10.0 cm.

According to a method of the present technology a composite material structure is manufactured in a process using the discontinuous fiber material 46. The composite material structure may be, for example, a component of an airplane or other vehicle.

First, a spool of discontinuous fiber material is placed in the creel 34 of the system 10. The discontinuous fiber material 46 is fed to the roller 40 such that the material 46 is interposed between the roller 40 and the surface 13. The roller 40 is urged toward the surface 13 such that the roller 40 engages the first side 54 of the material 46 and the second side 56 of the material 46 engages the surface 13.

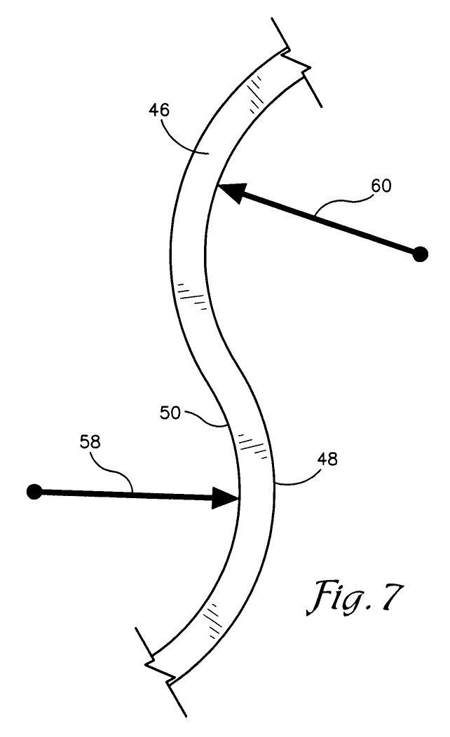

The material 46 is applied to the surface 13 by moving one of the roller 40 and the surface 13 relative to the other such that the roller 40 rolls along a path of the surface 13. With particular reference to FIG. 7, the path may include a first curve characterized by a first radius of curvature 58 such that a first path edge corresponding to the first longitudinal fiber edge 48 is longer than a second path edge corresponding to the second longitudinal fiber edge 50 through the first curve. The first radius of curvature 58 corresponds to the second (inside) edge 50 of the material 46.

The path may further include a second curve characterized by a second radius of curvature 60 such that the first path edge corresponding to the first longitudinal edge 48 is shorter through the second curve than the second path edge corresponding to the second longitudinal edge 50, wherein the second portion of the length of material 46 lengthens relative to the first portion of the material 46, thereby allowing the material 46 to lay evenly against the surface 13 through the second curve with little or no separation from the surface 13. The second radius of curvature 60 corresponds to the first (inside) edge 48 of the material 46.

This difference in lengths of the path edges through the first curve and the second curve may subject the material 46 to stress by, for example, causing a portion of the material 46 proximate an outer edge of each curve to be subject to extension forces. The discontinuous fiber material 46 relieves this stress wherein a plurality of fibers of the discontinuous fiber material 46 proximate the outer edge 48 of each curve slide relative one another, thereby allowing the portion of the material 46 proximate the outer edge of each curve to extend or lengthen relative to the portion of the material 46 proximate the inner edge of each curve, thereby allowing the material 46 to conform to the surface 13 without separating from the surface 13.

With reference to the first curve characterized by the first radius of curvature 58, a portion of the material 46 proximate the first edge 48 will lengthen relative to a portion of the material proximate the second edge 50, as explained above. The difference in length of the material 46 at the first edge 48 and the second edge 50 may be defined by the following equation:

PL_{d}=(TT×2rₒ×f)−(TT×2rᵢ×f)

where
PL_{d} is the difference in path length between the radially outer edge and the radially inner edge,
rₒ is the radius of curvature of the radially outer edge of the material,
rᵢ is the radius of curvature of the radially inner edge of the material, and
f is the fraction of the circumference of a circle (arc) represented by the curve.

By way of example, if the radius of curvature 58 is 70 cm, the curve represents an arc of 90°, and the width of the material 46 is 5.0 mm, the difference in path lengths PL_{d} is (3.14159×2×70.5×0.25)−(3.14159×2×70.0×0.25), or about 0.79 cm. If the radius of curvature 58 is 50 cm, the curve represents an arc of 60°, and the width of the material is 1.cm, the difference in path lengths PL_{d} is (3.14159×2×51.0×0.167)−(3.14159×2×50.0×0.167), or about 1.05 cm. These are but two examples.

The precise values of the first radius of curvature 58 and of the second radius of curvature 60 are not essential to the present technology. By way of example, however, the radii of curvature 58,60 may be within the range of from about 10 cm to about 130 cm, within the range of from about 30 cm to about 110 cm, or within the range of from about 50 cm to about 90 cm.

After the material 46 is applied to the surface 13, a resin impregnated in the material 46 is cured according to conventional methods. The resin may be impregnated in the material 46 prior to application on the surface 13, or may be impregnated in the material 46 after the material 46 is applied to the surface 13. The resin may be any resin known in the art, including thermosetting and thermoplastic resins.

As explained above, the precise width of the material 46 is not essential to the present technology and may vary significantly without departing from the ambit of the present teachings. If the length of material is 6.0 mm wide and the radius of curvature is 25 cm, the ratio of the radius of curvature to the width of the material is 25/0.6 or about 42. This ratio is of interest because, generally, increasing the width 52 of the material 46 or decreasing the radius of curvature 58,60 increases the difference in path lengths between the first edge 48 and the second edge 50 of the material 46. Thus, a material that may be applied along a curved path wherein a ratio of radius of curvature to width of the material is relatively low is generally more “steerable” and may be desirable in applications where greater steering is needed. By way of example, the ratio of the radius of curvature to the width of the material may be less than about 700, less than about 500, less than about 300, less than about 200, less than about 100, less than about 50, or less than about 20.

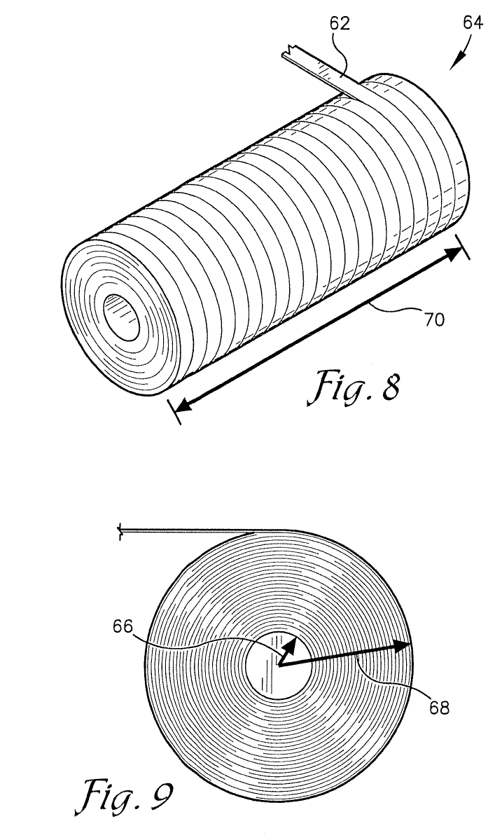

An exemplary quantity of discontinuous fiber material 62 is illustrated in FIGS. 8 and 9. The illustrated quantity of discontinuous fiber material is a spool 64 of stretch broken carbon fiber material, wherein a width of the material 62 (equivalent to the width 52 describe above) may be within the range of from about 1.0 mm to about 2.0 cm, within the range of from about 1.0 mm to about 20.0 cm, within the range of from about 5.0 mm to about 15.0 cm, or within the range of from about 1.0 cm to about 10.0 cm. The material 62 may be impregnated with a resin before it is wound into the spool 64.

An inner diameter 66 of the spool 64 may be within the range of from about 5.0 cm to about 9.0 cm, and may be 7.0 cm. An outer diameter 68 of the spool 64 may be within the range of from about 5.0 cm to about 50.0 cm, or may be about 30.0 cm. A length 68 of the spool may be within the range of from about 25.0 cm to about 45.0 cm. A length of the material 62 included in the spool 64 may be within the range of from 0.50 km to about 9.50 km. By way of example, a spool may contain 0.62 km of stretch broken carbon fiber one-fourth of an inch wide, wherein the overall spool weighs about 1.36 kg; a spool may contain 0.31 km of stretch broken carbon fiber one-half of an inch wide, wherein the overall spool weighs about 1.36 kg; and a spool may contain 9.15 km of stretch broken carbon fiber one-fourth of an inch wide, wherein the overall spool weighs about 18.15 kg.

An exemplary method of manufacturing the discontinuous fiber material 62 involves dividing the block of discontinuous fiber material into a plurality of strips, interconnecting the plurality of strips end-to-end to form a single length of discontinuous fiber material, and wrapping the length of discontinuous fiber material onto a spool. A second material may also be interposed between layers of the single length of discontinuous fiber material as it is wrapped onto the spool to prevent the layers from adhering one to another.

The block of discontinuous fiber material may comprise, for example, a stretch broken carbon fiber material and may be of virtually any size and shape prior to being divided. The block may have a width, for example, of eight inches, ten inches, twelve inches, fourteen inches, or twenty-four inches. The resulting plurality of strips of discontinuous fiber material may present a uniform width within the range of from about 0.3 cm to about 2.6 cm, or within the range of from about 0.64 cm to about 1.9 cm. More specifically, the resulting plurality of strips of discontinuous fiber material may present a uniform width of about 0.65 cm, about 0.95 cm, about 1.3 cm, about 1.6 cm, or about 1.9 cm.

The plurality of strips are interconnected end-to-end to form a single length or strip of discontinuous fiber material. An exemplary method of interconnecting the plurality of strips involves attaching a first end of a first strip to an end of a second strip by overlapping the two ends, heating the overlapped portions of the material, and pressing the overlapped portions of the material together. Then an end of a third strip is attached in a similar fashion to a second end of the first strip. This process is repeated until all of the strips have been interconnected.

The step of heating the overlapped portions of the material will be implemented according to the demands of a particular application and may vary from one implementation to another. By way of example, the step of heating the overlapped material may involve heating the material to a temperature within the range of from about 35° C. to about 90° C., or from about 40° C. to about 80° C.

The single strip of discontinuous fiber material is then wound or wrapped onto a spool. When the single strip of material is wound onto the spool, a protective material may be wound with it so that the protective material is interposed between layers of the discontinuous fiber material and prevents adjacent layers of the discontinuous fiber material from adhering one to another. The protective material may be virtually any material operable to prevent the various layers form adhering one to the other. By way of example, the protective material may be a plastic film, such as polyethylene, polyolefin, polypropylene, or cellophane. These are but a few examples.

Although the present technology has been described with reference to the preferred embodiments illustrated in the attached drawings, it is noted that equivalents may be employed and substitutions made herein without departing from the scope of the subject matter recited in the claims.

Having thus described preferred implementations of the present technology, what is claimed as new and desired to be protected by Letters Patent includes the following:

1. A method of applying a length of discontinuous fiber material to a surface, said method comprising:
placing said length of discontinuous fiber material between a roller and said surface, said length of discontinuous fiber material being substantially flat with a first longitudinal edge and a second longitudinal edge separated by a span of discontinuous fiber material;
urging said roller toward said surface such that said roller causes at least a portion of said length of discontinuous fiber material to engage said surface; and
applying said length of discontinuous fiber material to said surface by moving one of said roller and said surface relative to the other such that the roller rolls along a path of said surface, said path including a first curve such that a first path edge corresponding to said first longitudinal edge is longer through said first curve than a second path edge corresponding to said second longitudinal edge, wherein a first portion of said length of discontinuous fiber material proximate said first longitudinal edge lengthens relative to a second portion of said discontinuous fiber material proximate said second longitudinal edge, thereby allowing said length of discontinuous fiber material to lay evenly against said surface through said first curve without separating from said surface.

2. The method as set forth in claim 1, said application path including a second curve such that said first path edge corresponding to said first longitudinal edge is shorter through said second curve than said second path edge corresponding to said second longitudinal edge, wherein said second portion of said discontinuous fiber material lengthens relative to said first portion of said discontinuous fiber material, thereby allowing said length of material to lay evenly against said surface through said second curve without separating from said surface.

3. The method as set forth in claim 1, said first curve characterized by a radius of curvature R and said length of material presenting a width W, wherein the ratio R/W is less than 500.

4. The method as set forth in claim 1, said first curve characterized by a radius of curvature R and said length of material presenting a width W, wherein the ratio R/W is less than 200.

5. The method as set forth in claim 1, said first curve characterized by a radius of curvature R and said length of material presenting a width W, wherein the ratio R/W is less than 30.

6. The method as set forth in claim 1, said first curve characterized by a radius of curvature within the range of from 10 cm to 130 cm.

7. The method as set forth in claim 1, said first curve characterized by a radius of curvature within the range of from 30 cm to 110 cm.

8. The method as set forth in claim 1, said first curve characterized by a radius of curvature within the range of from 50 cm to 90 cm.

9. The method as set forth in claim 1, wherein said length of stretch broken carbon fiber has a width within the range of from 1.0 mm to 20.0 cm.

10. The method as set forth in claim 1, wherein said length of stretch broken carbon fiber has a width within the range of from 5.0 mm to 15.0 cm.

11. The method as set forth in claim 1, wherein said length of stretch broken carbon fiber has a width within the range of from 1.0 cm to 10.0 cm.

12. The method as set forth in claim 1, wherein said first portion of said length of discontinuous fiber material lengthens relative to said second portion of said discontinuous fiber material by a distance D defined by the equation
D=(TT×2rₒ×f)−(TT×2rᵢ×f),
where
r_{f} is the radius of curvature of said first portion,
rₛ is the radius of curvature of said second portion, and
f is a fraction of the circumference of a circle represented by said first curve.

13. A method of manufacturing a composite material structure, said method comprising:
placing a spool of stretch broken carbon fiber material in a material placement apparatus including a compaction roller, said spool of stretch broken carbon fiber material including a length of stretch broken carbon fiber material that is substantially flat with a first longitudinal fiber edge and a second longitudinal fiber edge separated by a span of said stretch broken carbon fiber, said span of said stretch broken carbon fiber including a first side and a second side, at least a portion of said length of stretch broken carbon fiber being impregnated with a resin;
feeding said length of stretch broken carbon fiber to said compaction roller such that said length of stretch broken carbon fiber is interposed between said compaction roller and a mold surface, said mold surface defining a shape of said composite material structure;
urging said compaction roller toward said mold surface such that said roller engages said first side of said length of stretch broken carbon fiber and said second side of said length of stretch broken carbon fiber engages said mold surface;
applying said length of stretch broken carbon fiber to said mold surface by moving one of said compaction roller and said surface relative to the other such that said compaction roller rolls along an application path of said mold surface, said path being curved such that a first path edge corresponding to said first longitudinal fiber edge is longer than a second path edge corresponding to said second longitudinal fiber edge, wherein a plurality of carbon fibers of said length of said stretch broken carbon fiber proximate said first longitudinal fiber edge move relative one another thereby allowing a first portion of said length of stretch broken carbon fiber proximate said first longitudinal fiber edge to stretch relative to a second portion of said stretch broken carbon fiber proximate said second longitudinal fiber edge, thereby allowing said length of stretch broken carbon fiber to conform to said mold surface without separating from said mold surface; and
curing said resin.

14. The method as set forth in claim 13, said application path including a second curve such that said first path edge corresponding to said first longitudinal fiber edge is shorter through said second curve than said second path edge corresponding to said second longitudinal fiber edge, wherein said second portion of said length of stretch broken carbon fiber lengthens relative to said first portion of said stretch broken carbon fiber, thereby allowing said length of stretch broken carbon fiber to lay evenly against said surface through said second curve without separating from said surface.

15. The method as set forth in claim 13, wherein said application path follows a radius of curvature within the range of from 10 cm to 130 cm.

16. The method as set forth in claim 13, wherein said application path follows a radius of curvature within the range of from 30 cm to 110 cm.

17. The method as set forth in claim 13, wherein said application path follows a radius of curvature within the range of from 50 cm to 90 cm.

18. The method as set forth in claim 13, wherein said length of stretch broken carbon fiber has a width within the range of from 1.0 mm to 20.0 cm.

19. The method as set forth in claim 13, wherein said length of stretch broken carbon fiber has a width within the range of from 5.0 mm to 15.0 cm.

20. The method as set forth in claim 13, wherein said length of stretch broken carbon fiber has a width within the range of from 1.0 cm to 10.0 cm.

21. The method as set forth in claim 13, wherein the ratio of the radius of curvature to the width of the material is less than 500.

22. The method as set forth in claim 13, wherein the ratio of the radius of curvature to the width of the material is less than 200.

23. The method as set forth in claim 13, wherein the ratio of the radius of curvature to the width of the material is less than 30.

24. A method of manufacturing a composite material structure, said method comprising:
placing a spool of stretch broken carbon fiber material in a material placement apparatus including a compaction roller, said stretch broken carbon fiber material including a first side and a second side, said stretch broken carbon fiber material being impregnated with a resin;
feeding said stretch broken carbon fiber material to said compaction roller such that said length of stretch broken carbon fiber is between said compaction roller and a mold surface, said mold surface defining a shape of said composite material structure;
urging said compaction roller toward said mold surface such that said roller engages said first side of said length of stretch broken carbon fiber and said second side of said length of stretch broken carbon fiber engages said mold surface;
applying said length of stretch broken carbon fiber to said mold surface by moving one of said compaction roller and said surface relative to the other such that said compaction roller rolls along an application path of said mold surface; and
curing said resin.

25. A spool of discontinuous fiber material comprising:
a length of stretch broken carbon fiber material with a width within the range of from 1.0 mm to 2.0 cm and a length within the range of from 0.50 km to about 9.50 km, wherein said length of stretch broken carbon fiber material is impregnated with a resin, wherein said length of stretch broken carbon fiber material is wound into a spool presenting an inner diameter of from 5.0 cm to 9.0 cm, wherein said spool presents an outer diameter of from 5.0 cm to 50.0 cm, and wherein said spool presents a length of from 25.0 cm to 45.0 cm.

26. A method of manufacturing a spool of discontinuous fiber material, said method comprising:
dividing a piece of discontinuous fiber material into a plurality of strips of discontinuous fiber material presenting a substantially uniform width;
interconnecting said plurality of strips end-to-end to form a single length of discontinuous fiber material; and
wrapping said single length of discontinuous fiber material onto a spool.

27. The method as set forth in claim 26, wherein interconnecting said plurality of strips end-to-end fashion to form a single length of discontinuous fiber material comprises:
overlapping an end of a first strip of material with an end of a second strip of material;
heating the overlapping portions of said first strip and said second strip; and
pressing said overlapping portions together to form an overlap splice.

28. The method as set forth in claim 26, further comprising interposing a second material between layers of said single length of discontinuous fiber material as it is wrapped onto said spool, said second material preventing said layers from adhering one to another.

29. The method as set forth in claim 26, wherein said piece of discontinuous fiber material is stretch broken carbon fiber material.
